(19) United States
(12) Patent Application Publication
(10) Pub. No.: US 2015/0042645 A1
(43) Pub. Date: Feb. 12, 2015

(54) PROCESSING APPARATUS FOR THREE-DIMENSIONAL DATA, PROCESSING METHOD THEREFOR, AND PROCESSING PROGRAM THEREFOR

(71) Applicant: Kabushiki Kaisha Toshiba, Minato-ku (JP)

(72) Inventors: Yuji KAWAGUCHI, Yokohama (JP); Yoshinori SATOH, Asakuchi (JP); Makoto HATAKEYAMA, Yokosuka (JP); Masahiro MOTOHASHI, Yokohama (JP); Tetsuo ENDOH, Fujisawa (JP); Shohei MATSUMOTO, Setagaya (JP)

(73) Assignee: Kabushiki Kaisha Toshiba, Minato-ku (JP)

(21) Appl. No.: 14/453,724

(22) Filed: Aug. 7, 2014

(30) Foreign Application Priority Data
Aug. 7, 2013 (JP) 2013-164521

(51) Int. Cl. G06T 15/08

(52) U.S. Cl. CPC G06T 15/08; G06T 2215/16
USPC 345/419

(57) ABSTRACT

According to one embodiment, a three-dimensional data processing apparatus includes: an acquiring unit configured to acquire point group data measured by a three-dimensional measuring instrument that emits a beam for scanning from one position in a space in which a target object exists; a discriminating unit configured to discriminate a region unirradiated with the beam in the space on a basis of the point group data; a coordinate integrating unit configured to integrate, into one global coordinate system, respective local coordinate systems at a plurality of the positions at each of which the three-dimensional measuring instrument is placed; and an extracting unit configured to extract an overlapping region formed by integrating, into the global coordinate system, the unirradiated regions discriminated in the respective local coordinate systems.

### CROSS-REFERENCE TO RELATED APPLICATIONS

This application is based upon and claims the benefit of priority from Japanese Patient application No. 2013-164521, filed on Aug. 7, 2013, the entire contents of each of which are incorporated herein by reference.

### BACKGROUND OF THE INVENTION

1. Field of the Invention

The present invention relates to a three-dimensional data processing technique for scanning a surface of a target object with a beam to thereby generate an image.

2. Description of the Related Art

A known technique includes: actually measuring a target object by means of a three-dimensional measuring instrument such as a laser scanner; acquiring point group data that is a set of three-dimensional point data; and recognizing a surface shape of the target object.

This technique also includes: acquiring a plurality of positions at each of which the laser scanner is placed; and synthesizing the pieces of point group data respectively acquired for the positions. Accordingly, this technique is widely used for three-dimensional informatization of large-scale complicated structures such as plants, work sites, cityscapes, and cultural property buildings (see, for example, Japanese Patent Laid-Open Nos. 2012-141758 and 2013-80391).

In order to three-dimensionally measure an entire image of a target object, it is necessary to set placement (a plurality of positions) of a laser scanner such that an entire space in which the target object exists is irradiated with a scanning beam.

In the case of three-dimensionally measuring a large-scale complicated structure such as a nuclear power plant, such position setting depends on experience and sense of a worker, and hence the worker may not notice in a work site that a region unirradiated with a beam exists in a space.

There is a possibility that the structure actually exists also in the space of this unirradiated region, and hence three-dimensional measurement results may not be effectively reflected in designs and plans of remodeling work and additional installation work of machines.

Meanwhile, in the case where 3D-CAD data, drawings, and the like of a target object placed in a space are available, it is possible to check whether or not there is an omission in measurement, through comparison and examination with three-dimensional measurement data, but the checking needs to be performed by manual work, and thus requires enormous time. Moreover, in the case of an old building whose drawing does not exist, such checking is not possible in the first place.

### SUMMARY OF THE INVENTION

An embodiment of the present invention, which has been made in view of the above-mentioned circumstances, has an object to provide a three-dimensional data processing technique that enables exact understanding of a region irradiated with a beam and a region unirradiated with the beam, in a space in which a target object is placed.

There is provided a three-dimensional data processing apparatus, the apparatus includes: an acquiring unit configured to acquire point group data measured by a three-dimensional measuring instrument that emits a beam for scanning from one position in a space in which a target object exists; a discriminating unit configured to discriminate a region unirradiated with the beam in the space on a basis of the point group data; a coordinate integrating unit configured to integrate, into one global coordinate system, respective local coordinate systems at a plurality of the positions at each of which the three-dimensional measuring instrument is placed; and an extracting unit configured to extract an overlapping region formed by integrating, into the global coordinate system, the unirradiated regions discriminated in the respective local coordinate systems.

According to the embodiment of the present invention having the above features provides a three-dimensional data processing technique that enables exact understanding of a region irradiated with a beam and a region unirradiated with the beam, in a space in which a target object is placed.

### BRIEF DESCRIPTION OF THE DRAWINGS

FIG. 1 is a block diagram illustrating a first embodiment of a three-dimensional data processing apparatus according to the present invention;

FIG. 2 is a view illustrating a region unirradiated with a beam emitted for scanning by a three-dimensional measuring instrument placed in a space, in the first embodiment;

FIG. 3 is a cross sectional view of the unirradiated region;

FIG. 4 is a view illustrating a two-dimensional image of a region unirradiated with a beam emitted for scanning from a first position;

FIG. 5 is a view illustrating a two-dimensional image of a region unirradiated with a beam emitted for scanning from a second position;

FIG. 6 is a view illustrating a two-dimensional image of a region unirradiated with a beam emitted for scanning from a third position;

FIG. 7 is a view illustrating a two-dimensional image of an overlapping region of the unirradiated regions respectively formed for the first, second, and third positions;

FIG. 8 is a flow chart showing an operation of a three-dimensional data processing apparatus according to the first embodiment;

FIG. 9 is a block diagram illustrating a second embodiment of the three-dimensional data processing apparatus according to the present invention;

FIG. 10 is a view illustrating a resolved region whose unirradiation is resolved by a beam emitted for scanning from a virtual position set in a space, in the second embodiment;

FIG. 11 is a flow chart showing an operation of a three-dimensional data processing apparatus according to the second embodiment; and

FIGS. 12A and 12B are explanatory views of a third embodiment of the three-dimensional data processing apparatus according to the present invention.

### DETAILED DESCRIPTION OF THE PREFERRED EMBODIMENTS

### First Embodiment

Hereinafter, an embodiment of the present invention is described with reference to the attached drawings.

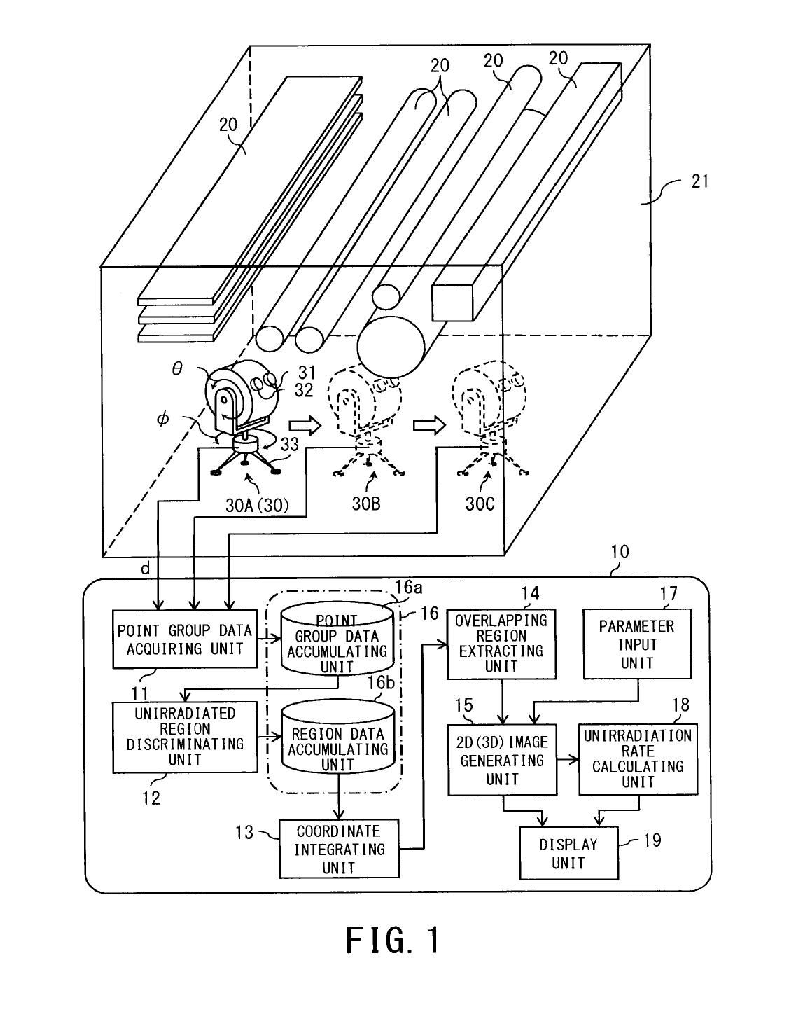

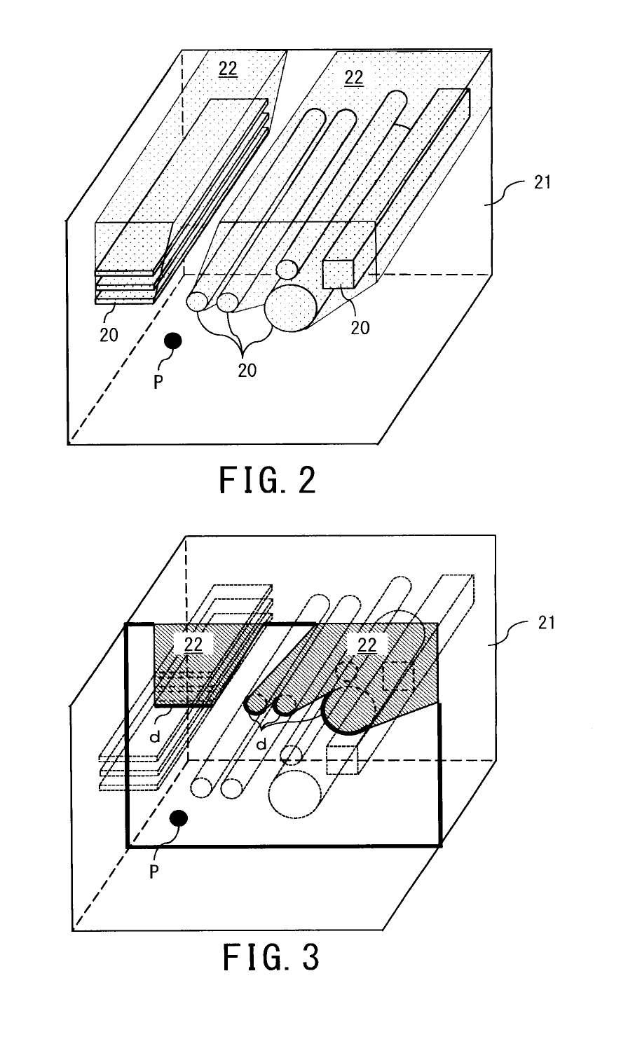

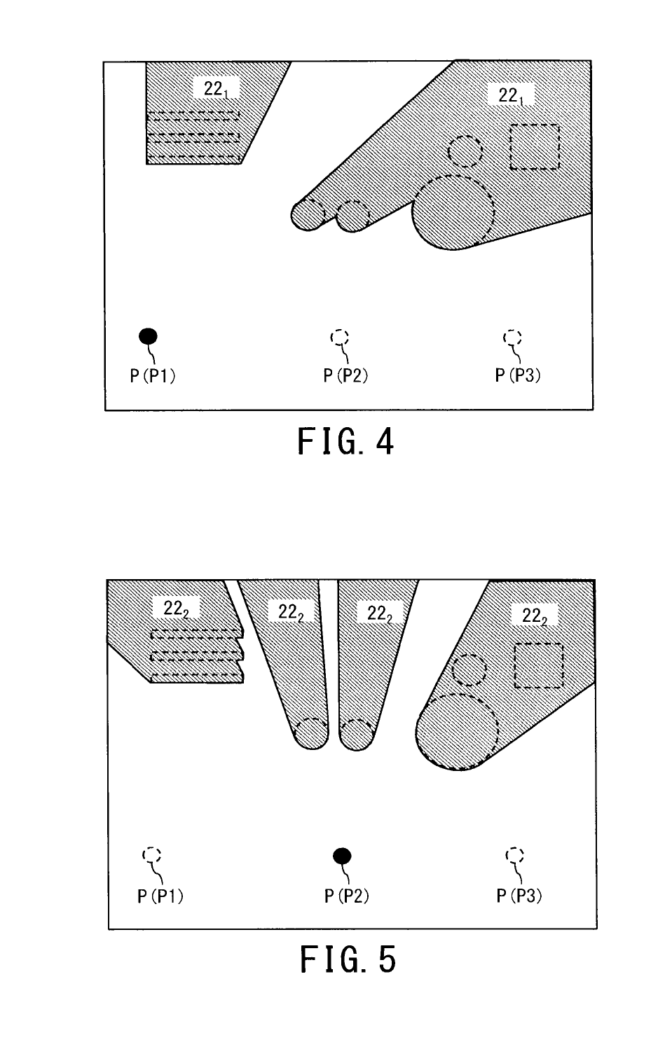

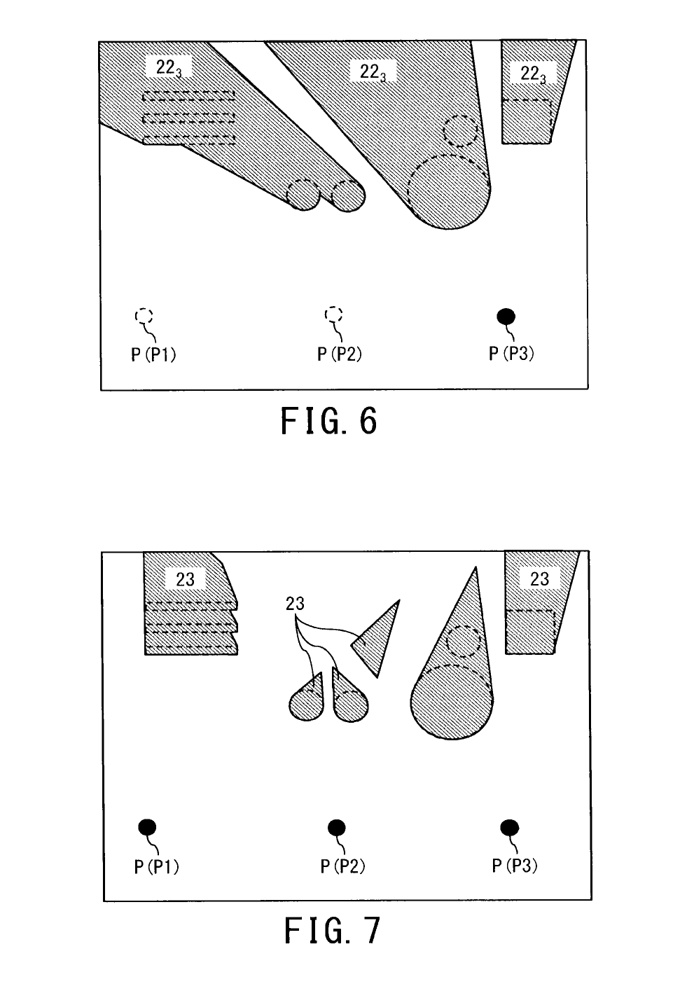

As illustrated in FIG. 1, a three-dimensional data processing apparatus 10 includes an acquiring unit 11, a discriminating unit 12, a coordinate integrating unit 13, an extracting unit 14, and a generating unit 15. The acquiring unit 11 is configured to acquire point group data d measured by a three-dimensional measuring instrument 30 that emits a beam for scanning from one position P (FIG. 2) in a space 21 in which a target object 20 exists. The discriminating unit 12 is configured to discriminate a region 22 (FIG. 2) unirradiated with the beam in the space 21 on the basis of the point group data d. The coordinate integrating unit 13 is configured to integrate, into one global coordinate system, respective local coordinate systems at a plurality of the positions P (P₁, P₂, P₃) (FIG. 4) at each of which the three-dimensional measuring instrument 30 is placed. The extracting unit 14 is configured to extract, as data, an overlapping region 23 (FIG. 7) formed by integrating, into the global coordinate system, the unirradiated regions 22 (22₁, 22₂, 22₃) (FIG. 4, FIG. 5, FIG. 6) discriminated in the respective local coordinate systems. The generating unit 15 is configured to generate an image on the basis of the data of the overlapping region 23 and input parameters.

A laser scanner 30 given as an example of the three-dimensional measuring instrument 30 includes: an output unit 31 configured to output a pulsed laser and irradiate a surface of the target object 20 therewith; a light receiving unit 32 configured to receive reflected light from the target object 20; and a tripod 33 configured to fix the output unit 31 and the light receiving unit 32 to the position P (FIG. 2) as a reference.

The output unit 31 and the light receiving unit 32 include a rotation mechanism (pan mechanism) in a horizontal direction φ and a swing mechanism (tilt mechanism) in a vertical direction θ. The output unit 31 and the light receiving unit 32 transmit and receive laser beams to and from the target object 20 within a range of substantially 360 degrees around the position P (FIG. 2).

At one position in the space 21, a laser scanner 30A scans a surface of the target object 20 with a laser beam, whereby the acquiring unit 11 acquires the point group data d.

After that, at other positions in the space 21, laser scanners 30B and 30C similarly scan other surfaces of the target object 20 with laser beams, respectively, whereby the acquiring unit 11 similarly acquires the point group data d.

Here, the point group data d obtained by laser scanning for one point generates pixels of approximately tens of millions of dots.

A round-trip time from when a laser beam is outputted by the output unit 31 to when reflected light thereof is received by the light receiving unit 32 is measured, whereby a propagation distance from the position P to a reflection point on a surface of the target object 20 is obtained. An output direction of the laser beam is derived from the horizontal direction φ and the vertical direction θ obtained by the pan mechanism and the tilt mechanism.

Part of the reflected light received by the light receiving unit 32 is treated as point group data through threshold processing, the part having a given signal intensity or higher.

The point group data contains position information of the surface of the target object 20 based on the output direction and the propagation distance of the laser beam, and is defined in each of the local coordinate systems at the positions P (P₁, P₂, P₃) (FIG. 4).

The pieces of point group data d respectively expressed in the local coordinate systems are converted and synthesized into a common global coordinate system, whereby surface shape data of the target object 20 can be obtained.

The adoptable three-dimensional measuring instrument 30 is not limited to the laser scanner given as an example in the embodiment. Examples of the adoptable three-dimensional measuring instrument 30 include: devices that emit for scanning, as beams, electromagnetic waves or ultrasonic waves ranging from light having directionality other than laser light to radio waves; and stereo vision devices.

The point group data acquiring unit 11 acquires the point group data d for each position at which the three-dimensional measuring instrument 30 (30A, 30B, 30C) is placed, and accumulates the point group data d in an accumulating unit 16a.

The point group data d acquired by the acquiring unit 11 is associated with posture information and position information in the global coordinate system, of the three-dimensional measuring instrument 30 placed at the position P set as a reference.

The posture information is information determined by a rotation angle about an X axis, a rotation angle about a Y axis, and a rotation angle about a Z axis in the global coordinate system, and is obtained, for example, by providing an electronic compass including a three-dimensional magnetic sensor, to the three-dimensional measuring instrument 30.

The position information is obtained, for example, by directly measuring the position P at which the three-dimensional measuring instrument 30 is placed, by means of a laser range finder, an ultrasonic range finder, a stereo vision device, or the like, or by providing a global positioning system (GPS) sensor to the three-dimensional measuring instrument 30.

As illustrated in FIG. 2, the unirradiated region 22 refers to a region in the space 21 that is unirradiated with a beam because the beam is blocked by the target object 20.

As illustrated in a cross section of the unirradiated region 22 in FIG. 3, the point group data d exists only in portions indicated by thick solid lines.

It is considered that the target object 20 does not exist in an area of the space 21 between: the position P from which a beam is emitted for scanning; and a position at which a straight line that is extended in an arbitrary direction from the position P reaches each portion in which the point group data d exists.

Meanwhile, an area of the space 21 on a deeper side of each portion in which the point group data d exists is a region in which whether or not the target object 20 exists is unknown, because this area is a region unirradiated with the beam.

The unirradiated region discriminating unit 12 (FIG. 1) discriminates the region 22 (FIG. 2) unirradiated with the beam in the space 21, on the basis of the position information of the point group data d, in each local coordinate system in which the position of the position P is defined as the origin.

In this way, the point group data d and the unirradiated region 22 acquired for each different position P are expressed in each local coordinate system in terms of the position information, and are accumulated in an accumulating unit 16b.

The coordinate integrating unit 13 (FIG. 1) integrates, into one global coordinate system, the respective local coordinate systems at the plurality of positions P (P₁, P₂, P₃) at which the three-dimensional measuring instruments 30 (30A, 30B, 30C) are respectively placed. As a result, pieces of three-dimensional shape data of the target object 20 can be integrally coupled.

Methods adoptable to integrate the local coordinate systems into one global coordinate system can include an iterative closest point (ICP) method, which is a known technique, in addition to the above-mentioned method using the posture information and the position information of the three-dimensional measuring instrument 30 that are associated with the point group data d.

The ICP method is a method for positioning by minimizing (converging) a sum of squares of closest point distances through iterative calculation, for each piece of point group data to be subjected to the positioning.

The adoptable methods further include a method of integrating the coordinate systems by placing markers in the space 21.

The overlapping region extracting unit 14 extracts the overlapping region 23 (FIG. 7) formed by integrating, into the global coordinate system, the unirradiated regions 22 (22₁, 22₂, 22₃) (FIG. 4, FIG. 5, FIG. 6) discriminated in the respective local coordinate systems.

In the case where the position P from which a beam is emitted for scanning is added for measurement, a new local coordinate system is integrated into the global coordinate system, and data of the overlapping region 23 (FIG. 7) of the unirradiated regions 22 is extracted.

The image generating unit 15 generates a three-dimensional image or a two-dimensional image from the extracted data of the overlapping region 23 of the unirradiated regions 22, and displays the image on a display unit 19. In the three-dimensional image, the overlapping region 23 is stereoscopically displayed while being looked down at (observed) from an arbitrary direction. In the two-dimensional image, the overlapping region 23 is displayed while a cross section thereof is projected onto a plane.

The generated three-dimensional image is formed of, for example, a combination of so-called polygon meshes such as triangle meshes, and the position and direction in which the overlapping region 23 is looked down at are set on the basis of parameters inputted from an input unit 17.

Similarly, a cross section of the generated two-dimensional image is arbitrarily set on the basis of the parameters inputted from the input unit 17.

The unirradiated region 22 includes a region occupied by the target object 20 and a region occupied by the space 21, and the two regions cannot be distinguished from only information of the generated image.

Meanwhile, CAD information of the target object 20 as design drawings may exist.

Accordingly, a CAD model in which the target object 20 is placed in the global coordinate system is generated on the basis of the CAD information of the target object 20, and an image in which the CAD model is superimposed on the overlapping region 23 is generated by the image generating unit 15.

This makes a positional relation of the target object 20 occupying the unirradiated region 22 clear, and a region of the space 21 that is not irradiated with a beam can be exactly recognized.

An unirradiation rate calculating unit 18 calculates an unirradiation rate or an irradiation rate on the basis of largeness information of the space 21 and largeness information of the overlapping region 23. The calculated unirradiation rate or irradiation rate can be displayed on the display unit 19.

The largeness information may be a volume of each of the space 21 and the overlapping region 23 derived from the three-dimensional image generated by the image generating unit 15, may be an area of each of the space 21 and the overlapping region 23 derived from the two-dimensional image generated by the image generating unit 15, and may be a distance from one position in the space 21 to an end of the space 21 or the target object 20.

For example, in the case of a rate of irradiation in a given direction from one position arbitrarily defined in the space 21, distances to an end of the space 21 and the target object 20 in the given direction are used as the largeness information, and the irradiation rate in this case can be given as a rate of: the distance to the target object 20; to the distance to the end of the space 21.

In this way, if the position P from which a beam is emitted for scanning is determined as one, the irradiation rate can be easily calculated.

Moreover, in the case of such cross sectional views as illustrated in FIG. 4 to FIG. 7, for example, for each position on the cross sectional views, a sum of distances to ends of the space 21 in directions normal to cross sections and a sum of distances of the overlapping region 23 in the normal directions are respectively used as the largeness information, and the unirradiation rate in this case can be obtained as a rate of: the sum of the distances of the overlapping region 23; to the sum of the distances to the ends of the space 21.

In this way, if the unirradiation rate at each position on the cross sectional views is obtained, gradation display on the display unit 19 according to the unirradiation rate is possible.

It goes without saying that, if any one of the irradiation rate and the unirradiation rate is obtained, another thereof can be obtained by subtraction from one (100%).

Because the overlapping region 23 includes the region occupied by the target object 20 as described above, the unirradiation rate cannot be zero (the irradiation rate cannot be one (100%)) even in an ideal state as long as the target object 20 exists, but the unirradiation rate and the irradiation rate can serve as criteria for determining whether or not the target object 20 is exhaustively irradiated with a beam.

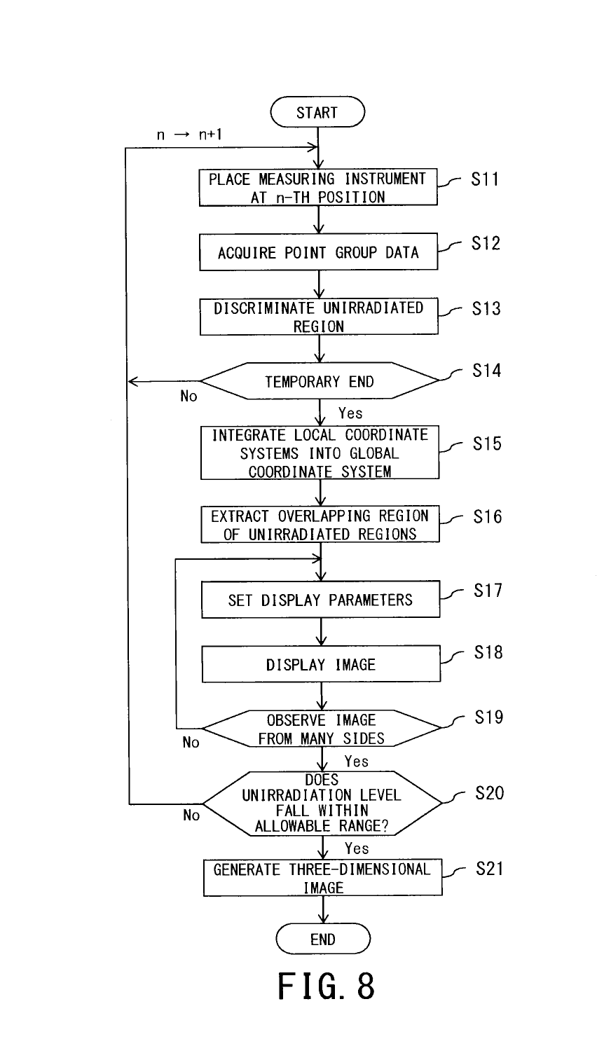

An operation of the three-dimensional data processing apparatus according to the first embodiment is described with reference to a flow chart of FIG. 8 (see FIG. 1 as appropriate).

The three-dimensional measuring instrument 30 is placed at the first position P₁ in the space 21 (n=1) (S11). A beam is emitted for scanning in all directions, and the point group data d is acquired (S12).

Then, in the local coordinate system in which the first position P₁ is defined as the origin, the unirradiated region 22 is discriminated (S13).

Subsequently, the three-dimensional measuring instrument 30 is moved in the space 21 (n=2, 3, . . . ). Similarly to the above, at the n-th position Pₙ, the point group data d is acquired, and the unirradiated region 22 is discriminated. The measurement is temporarily ended (S14).

The plurality of local coordinate systems in each of which the n-th position Pₙ (n=1, 2, 3, . . . ) is defined as the origin are integrated into the global coordinate system (S15), and the overlapping region 23 in which the respective unirradiated regions 22 in the local coordinate systems overlap with one another is extracted (S16).

While settings of various parameters (such as a point of view, a direction, and a cross section) for displaying an image of the extracted overlapping region 23 are switched (S17, S18), the image of the overlapping region 23 of the unirradiated regions 22 is observed from many sides (No, Yes in S19).

Then, it is determined whether or not the unirradiated region 22 level in the space 21 falls within an allowable range. If it is determined that the unirradiated region 22 level does not fall within the allowable range (No in S20), the three-dimensional measuring instrument 30 is placed at a new position in the space 21, and the flow from (S11) to (S19) is repeated until the unirradiated region 22 level reaches the allowable range (Yes in S20).

Lastly, the pieces of point group data acquired for all the positions P are synthesized into the global coordinate system, and the three-dimensional image expressing the surface shape of the target object 20 in the space 21 is formed (END in S21).

As described above, according to the first embodiment, with the use of the data generated by extracting the overlapping region 23 in which the unirradiated regions 22 overlap with one another, a region irradiated with a beam and a region unirradiated with the beam in the space 21 can be efficiently distinguished.

Further, in the state where the region unirradiated with the beam is understood, an appropriate placement position of the three-dimensional measuring instrument 30 can be added.

### Second Embodiment

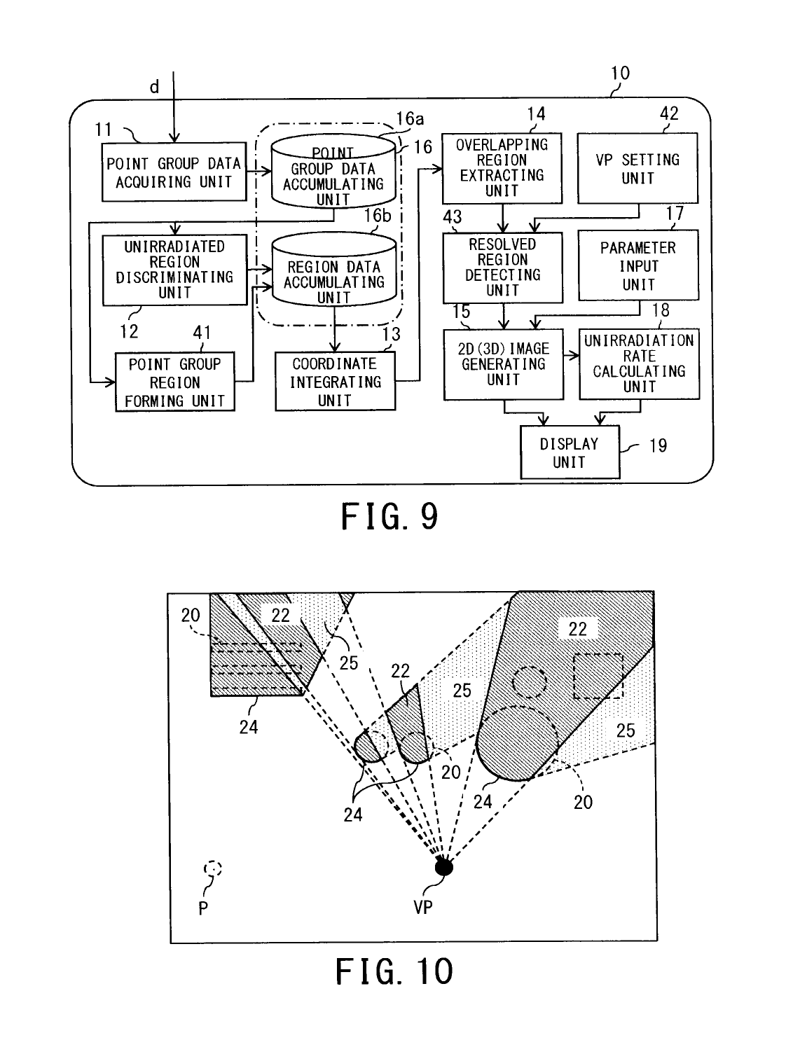

As illustrated in FIG. 9 and FIG. 10, a three-dimensional data processing apparatus 10 according to a second embodiment includes a forming unit 41, a setting unit 42, and a detecting unit 43, in addition to the configuration (FIG. 1) of the first embodiment. The forming unit 41 is configured to form a point group region 24 in a surface portion of the target object 20 irradiated with a beam. The setting unit 42 is configured to set a virtual position VP to the global coordinate system. The detecting unit 43 is configured to detect, as a resolved region 25, the unirradiated region 22 whose unirradiation is resolved when a beam that is not transmitted through the point group region 24 is emitted for scanning from the virtual position VP.

In FIG. 9, components having configurations or functions common to those in FIG. 1 are denoted by the same reference signs, and redundant description thereof is omitted.

As illustrated in FIG. 10, the point group region forming unit 41 forms the point group region 24 in the surface portion of the target object 20 irradiated with the beam, in the local coordinate system in which the position P from which the beam is emitted for scanning by the three-dimensional measuring instrument 30 is defined as the origin.

The unirradiated region 22 at the position P in FIG. 10 is coincident with that in FIG. 4.

The coordinate integrating unit 13 integrates both the point group region 24 and the unirradiated region 22 in the local coordinate system, into the global coordinate system.

The virtual position setting unit 42 manually or automatically sets the virtual position. In the case of the automatic setting, the virtual position setting unit 42 sets grid lines at regular intervals to the global coordinate system, and sets the virtual position VP such that the virtual position VP sequentially moves from one grid position to another grid position of the grid lines.

The resolved region detecting unit 43 detects, as the resolved region 25, a portion irradiated with a beam emitted for scanning from the virtual position VP, of the unirradiated region 22 displayed in the global coordinate system, in the state where the virtual position VP illustrated in FIG. 10 is defined as a reference position.

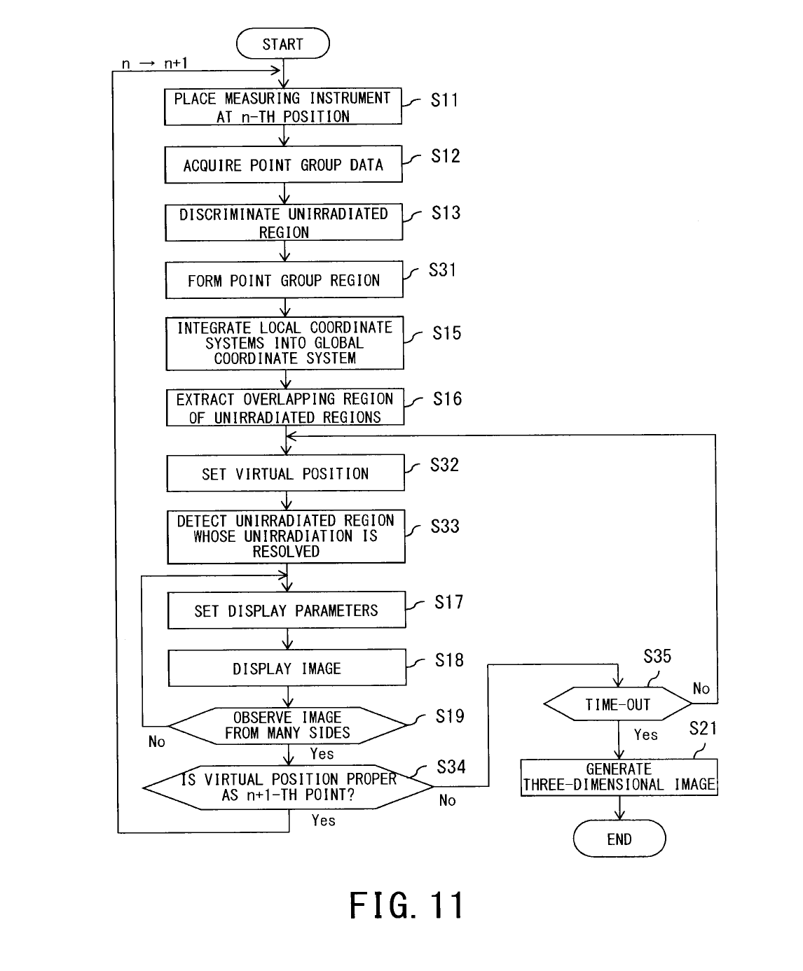

An operation of the three-dimensional data processing apparatus according to the second embodiment is described with reference to a flow chart of FIG. 11 (see FIG. 1 as appropriate). In FIG. 11, steps common to those in FIG. 8 are denoted by the same reference signs.

The three-dimensional measuring instrument 30 is placed at the first position P₁ in the space 21 (S11). A beam is emitted for scanning in all directions, and the point group data d is acquired (S12).

Then, in the local coordinate system in which the first position P₁ is defined as the origin, the unirradiated region 22 is discriminated (S13).

Subsequently, the point group region 24 is formed in the surface portion of the target object 20 irradiated with the beam (S31), and the local coordinate system in which the first position P₁ is defined as the origin is integrated into the global coordinate system (S15). In the case of n=1, the unirradiated region 22 is extracted as the overlapping region 23 as it is (S16).

Subsequently, the unirradiated region 22 whose unirradiation is resolved by irradiation with the beam emitted for scanning from the virtual position VP set in the global coordinate system is detected as the resolved region 25 (S32, S33).

While settings of various parameters (such as a point of view, a direction, and a cross section) for displaying an image of the overlapping region 23 excluding the resolved region 25 are switched (S17, S18), the image of the overlapping region 23 of the unirradiated regions 22 is observed from many sides (No, Yes in S19). At this time, calculation results of the unirradiation rate are referred to, as appropriate.

Then, it is determined whether or not the set virtual position VP is proper as the second position P₂, while taking a given period of time. If it is determined that the set virtual position VP is not proper (No in S34, No in S35), a different virtual position VP is set (S32).

Steps of (S33 and S17 to S19) are repeated for the different virtual position VP. If it is determined that the different virtual position VP is proper as the second position P₂ (Yes in S34), the three-dimensional measuring instrument 30 is placed at a position corresponding to the different virtual position VP (S11). Through repetition of this operation, the plurality of local coordinate systems in each of which the n-th position Pₙ (n=1, 2, 3, . . . ) is defined as the origin are integrated into the global coordinate system (S15), and the overlapping region 23 in which the respective unirradiated regions 22 in the local coordinate systems overlap with one another is extracted (S16).

Then, if a loop formed by (No in S34, No in S35) is repeated and if it is determined that a reduction in the overlapping region 23 of the unirradiated regions 22 reaches its limit, this loop is timed out (Yes in S35).

Lastly, the pieces of point group data acquired for all the set positions Pₙ (n=1, 2, 3, . . . ) are synthesized into the global coordinate system, and the three-dimensional image expressing the surface shape of the target object 20 in the space 21 is formed (END in S21).

As described above, according to the second embodiment, the position P at which the three-dimensional measuring instrument 30 is to be placed in the space 21 is determined while a range of the resolved region 25 of unirradiation is checked.

As a result, an appropriate placement position of the three-dimensional measuring instrument 30 that is efficient and reduces an omission in beam irradiation can be determined.

### Third Embodiment

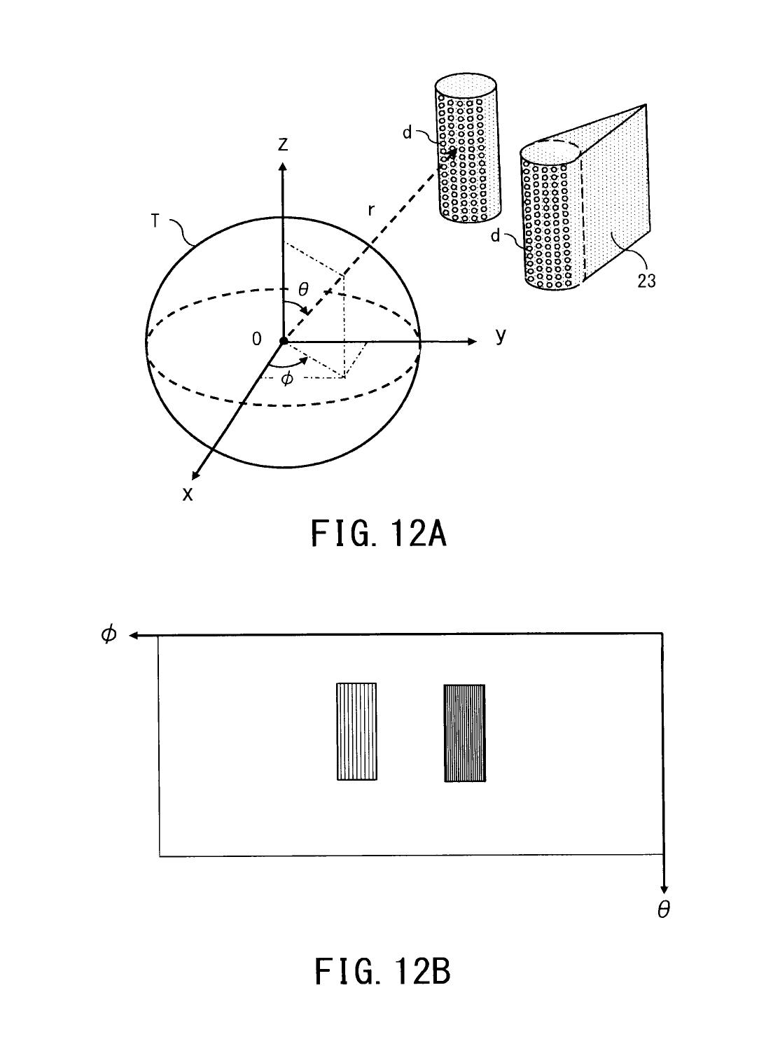

As illustrated in FIG. 12A, an image generating unit 15 in a three-dimensional data processing apparatus according to a third embodiment functions as a panorama image generating unit. The panorama image generating unit is configured to add depth information of the overlapping region 23 to a panorama image (FIG. 12B) obtained by projecting the point group data d onto a spherical surface T whose center is located at a point of view O that is set as an input parameter at an arbitrary position in the space 21.

Other configurations are the same as those of the three-dimensional data processing apparatus according to the first embodiment or the second embodiment.

The panorama image refers to an image in which the point group data d is expressed in a polar coordinate system using a distance r from the origin and two angles θ and φ, as illustrated in FIG. 12A.

As illustrated in FIG. 12B, a panorama projection image can be generated by developing the point group data d onto a two-dimensional plane whose ordinate is the angle θ and whose abscissa is the angle φ.

The depth information of the overlapping region 23 added to the panorama projection image refers to a display color and a luminance value corresponding to a largeness of a region that exists on a deeper side of the projected point group data d.

The display color is calculated so as to be, for example, redder as a depth of the overlapping region 23 that exists on the deeper side of the point group data d is larger, and bluer as the depth thereof is smaller.

Alternatively, the display color may be calculated such that the luminance value is smaller as the depth of the overlapping region 23 that exists on the deeper side of the point group data d is larger and that the luminance value is larger as the depth thereof is smaller.

The unirradiation rate (or the irradiation rate) described in the first embodiment can also be used as the depth information. In this case, a distance from the point of view O to an end of the space 21 in each direction and a distance therefrom to the target object 20 in each direction are used as the largeness information.

Moreover, the origin position (point of view O) as the reference of the panorama projection image to be generated is not limited to the origin position of the global coordinate system, and can be set as an input parameter to an arbitrary three-dimensional position.

As described above, according to the third embodiment, it is possible to provide two-dimensional information that enables a region that is not irradiated with a beam in the space 21 to be understood at a glance.

In the three-dimensional data processing apparatus of at least one embodiment described above, the unirradiated region is discriminated for each position from which a beam is emitted for scanning, and the overlapping region of the unirradiated regions respectively corresponding to the plurality of positions is extracted and imaged, whereby a region that is not irradiated with the beam in the space can be exactly understood.

It should be noted that, although some embodiments of the present invention have been described above, these embodiments are presented as examples, and are not intended to limit the scope of the invention. These embodiments can be implemented in other various forms, and various abbreviations, exchanges, changes and combinations can be made within a scope not deviating from the essence of the invention. These embodiments and their modifications are included in the scope and the essence of the invention, and are included in the invention described in the claims, and the equal scope thereof.

What is claimed is:

1. A three-dimensional data processing apparatus, comprising:
an acquiring unit configured to acquire point group data measured by a three-dimensional measuring instrument that emits a beam for scanning from one position in a space in which a target object exists,
a discriminating unit configured to discriminate a region unirradiated with the beam in the space on a basis of the point group data,
a coordinate integrating unit configured to integrate, into one global coordinate system, respective local coordinate systems at a plurality of the positions at each of which the three-dimensional measuring instrument is placed, and
an extracting unit configured to extract an overlapping region formed by integrating, into the global coordinate system, the unirradiated regions discriminated in the respective local coordinate systems.

2. The three-dimensional data processing apparatus according to claim 1, further comprising a generating unit configured to generate an image from the overlapping region, wherein
the image generated by the generating unit is at least any of: a three-dimensional shape taken from an arbitrary direction of the overlapping region in the space; and an arbitrary cross section of the overlapping region.

3. The three-dimensional data processing apparatus according to claim 1, further comprising a calculating unit, wherein
the calculating unit configured to calculate at least one of an irradiation rate and an unirradiation rate on a basis of largeness information of the space and largeness information of the overlapping region.

4. The three-dimensional data processing apparatus according to claim 1, further comprising:
a forming unit configured to form a point group region on a surface of the target object irradiated with the beam,
a setting unit configured to set a virtual position to the global coordinate system, and
a detecting unit configured to detect, as a resolved region, the unirradiated region whose unirradiation is resolved when a beam that is not transmitted through the point group region is emitted for scanning from the virtual position.

5. The three-dimensional data processing apparatus according to claim 1, further comprising a panorama image generating unit, wherein
the panorama image generating unit configured to generate an image in which depth information based on largeness information of the overlapping region is added to a panorama image obtained by projecting the point group data onto a spherical surface whose center is located at a point of view set at an arbitrary position in the space.

6. The three-dimensional data processing apparatus according to claim 1, further comprising a generating unit configured to generate an image from the overlapping region, wherein
the generating unit generates an image in which a CAD model of the target object is superimposed on the overlapping region.

7. A three-dimensional data processing method, comprising the steps of:
accumulating point group data measured by a three-dimensional measuring instrument that emits a beam for scanning from one position in a space in which a target object exists;
discriminating a region unirradiated with the beam in the space on a basis of the point group data;
integrating, into one global coordinate system, respective local coordinate systems at a plurality of the positions at each of which the three-dimensional measuring instrument is placed; and
extracting an overlapping region formed by integrating, into the global coordinate system, the unirradiated regions discriminated in the respective local coordinate systems.

8. A three-dimensional data processing program, causing a computer to execute the steps of:
accumulating point group data measured by a three-dimensional measuring instrument that emits a beam for scanning from one position in a space in which a target object exists;
discriminating a region unirradiated with the beam in the space on a basis of the point group data;
integrating, into one global coordinate system, respective local coordinate systems at a plurality of the positions at each of which the three-dimensional measuring instrument is placed; and
extracting an overlapping region formed by integrating, into the global coordinate system, the unirradiated regions discriminated in the respective local coordinate systems.
